(19) United States
(12) Patent Application Publication
(10) Pub. No.: US 2006/0131875 A1
(43) Pub. Date: Jun. 22, 2006

(54) Self-tightening hose clamp

(75) Inventor: Michael J. Zielinski, Gladstone, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Rotor Clip Company, Inc., Somerset, NJ (US)

(21) Appl. No.: 10/999,009

(22) Filed: Nov. 29, 2004

(51) Int. Cl. F16L 33/00

(52) U.S. Cl. 285/242

(57) ABSTRACT

A method of applying a self-tightening hose clamp including the steps of providing a self-tightening hose clamp having a flexible member with a substantially circular shape and disposed in a first plane. The flexible member being expandable from a first position defining a first opening to a second position defining a second opening, the second opening being larger than the first opening. The flexible member also having first and second spaced apart ends. The flexible member is expanded from the first position to the second position. A first tubular member is then received in the opening of the hose clamp and the hose clamp is translated in a first direction along the first tubular member. The tubular member having a hollow chamber extending therethrough. A second tubular member is placed within the hollow chamber of the first tubular member, and the hose clamp is translated along the first tubular member to a position overlapping the second tubular member. The hose clamp is then allowed to contract back to the first position from the second position.

### BACKGROUND OF THE INVENTION

The present invention relates to hose clamps which are used for securing or clamping a hose or flexible pipe on an insert of corresponding cross-sectional shape, such as a further hose or pipe.

Common hose clamps are made in several different sizes for the various sizes of hose connections used in fluid systems of all kinds, such as engine water-cooling systems, air pressure systems and many other gas and liquid circuits. The rings of the hose clamp are generally made of a spring wire, with overlapping side-by-side ends turning outwardly at their extremities to form ears extending radially from the ring and spaced angularly in accordance with the amount of overlap of the ring ends.

A hose clamp is installed or removed by squeezing the ears together to cause the ring to increase in circumference in order that it may be slipped over the hose and moved to the proper clamping position. Once the clamp is positioned correctly, the ears are released allowing the ring or rings to resiliently tighten themselves around the hose. Similarly, the same process may be used to translate the hose clamp along a hose.

The hoses may consist of a reinforcing member which is a continuously helical wound coil having spaced turns, covered by an outer tube made of polymeric material. Such a hose is generally used for conveying water or air under low pressure. The two may be extruded or formed of a helical strip which is continuously formed over the reinforcing member. It is also possible to make a hose of this type by using a reinforcement of longitudinally-spaced angular turns. The clamp is secured to the reinforcing member in such a manner that the end of the hose may be expanded when it is desired to place the end of the hose over an adjacent tubular member such as a fitting, flange, coupling or duct.

In the method of use, a hose clamp is first placed around a hose, tubular member or pipe. The hose, tubular member or pipe is then connected to a second tubular member such as a coupling or additional pipe. Such a connection may include the hose having the hose clamp disposed on it, being circumferentially mounted to the second pipe. In order to accomplish this, the opening of the hose may have a larger inner diameter than the outer diameter of the pipe or the hose may include a flexible end allowing the inner diameter of the hose to extend and to increase in size. In either case, the pipe can be slidably received within the inner diameter of the hose. Once the hose and pipe have been coupled together, the hose clamp may be translated along the hose until reaching the connection point. As previously mentioned, in order to translate the hose clamp along the hose, normally two ears of the hose clamp are brought proximate to one another which causes the hose clamp to go from a first diameter at an at rest position to a second diameter at an open position. The open position diameter is larger than the at rest position diameter allowing for this translation.

Prior art hose clamps have been designed so that a person may either, with a tool or by hand, grip the hose clamp, specifically the two ears, from a position orthogonal to a line of movement of the hose clamp as it is translated about the hose.

### SUMMARY OF THE INVENTION

The present invention relates to a self-tightening hose clamp having a flexible member. The flexible member is preferably substantially circular and disposed within a first plane. The flexible member is expandable from a first position defining a first opening to a second position defining a second opening, with the second opening being larger than the first opening. The flexible member also includes first and second ends preferably spaced apart.

The self-tightening hose clamp also includes a first projection extending from the first end of the flexible member on one side of the first plane. The first projection having a longitudinal axis arranged substantially perpendicular to the first plane. Additionally, the self-tightening hose clamp includes a second projection extending from the second end of the flexible member on one side of the first plane. The second projection having a longitudinal axis arranged substantially perpendicular to the first plane, wherein a manipulation of the fist and second projections towards each other causes the flexible member to expand from the first position to the second position.

The first projection is preferably coupled to the first end by a first elbow and the second projection may also be coupled to the second end by a second elbow. The first and second ends may have flattened surfaces.

In another aspect of the present invention, the self-tightening hose clamp preferably includes a substantially circular shape member disposed in a first plane. The member defines a substantially circular opening and includes end portions overlapping one another. The self-tightening hose clamp also includes a first leg extending from one of the end portions on one side of the first plane at a first angle thereto and a second leg extending from the other of said end portions on said one side of the first plane at said first angle thereto. Displacement of the first and second legs towards each other causes the opening to increase in size by expansion of the member.

In one preferred embodiment, the first angle is in a range of about 75-115 degrees and more preferably is about 90 degrees. The first and second legs may be coupled to the end portions by elbows. The elbows preferably form a 90 degree angle. The end portions may include straight segments.

In another aspect of the present invention, a self-tightening hose clamp includes a flexible arcuate portion having a substantially circular shape. The arcuate portion preferably defines an aperture and is disposed in a plane. The arcuate portion preferably has a first diameter when in an at rest position and a second diameter when in an open position. The arcuate portion also preferably includes a first end and a second end. The self-tightening hose clamp further preferably includes a first extension extending from the first end and including a first elbow and a first ear. The first elbow and first ear are preferably disposed within a first plane. The first plane is preferably orthogonal to the plane of the arcuate portion. The self-tightening hose clamp also preferably includes a second extension extending from the second end and having a second elbow and a second ear. The second elbow and second ear preferably are disposed within a second plane which is orthogonal to the plane of the arcuate portion. When the first ear and second ear are brought proximate to one another, the arcuate portion is caused to expand from the first position to the second position.

The first extension and second extension may also include a first leg and a second leg. The first leg is preferably connected to the first end of the arcuate portion and to the first elbow and the second leg is preferably connected to the second end of the arcuate portion and a second elbow. In one preferred embodiment, the first leg or second leg is disposed in the first plane. In an additional embodiment, neither the first leg nor the second leg may be disposed in the first plane.

The first ear and the second ear may be at an angle to the plane of the arcuate portion with the angle being approximately between 75 degrees and 115 degrees. More preferably, the first ear and the second ear may be at an angle to the first plane and in a range of between approximately 80 degrees and 110 degrees.

In another additional aspect of the present invention, a method of applying a self-tightening hose clamp includes the steps of providing a flexible member having a substantially circular shape disposed in a first plane. The flexible member is expandable from a first position defining a first opening to a second position defining a second opening, the second opening being larger than the first opening. The flexible member preferably includes a first projection extending from the first end on one side of the first plane and having a longitudinal axis arranged substantially perpendicular to the first plane. Additionally, the flexible member preferably also includes a second projection extending from the second end of the flexible member on one side of the first plane. The second projection having a longitudinal axis arranged substantially perpendicular to the first plane, wherein a manipulation of the first and second projections towards each other causes the flexible member to expand from the first position to the second position.

The method of applying a self-tightening hose clamp preferably also includes the steps of expanding the flexible member from the first position to the second position and slidably receiving a first tubular member in the opening of the hose clamp and translating the hose clamp in a first direction along the first tubular member. The first tubular member preferably has a hollow chamber extending therethrough. Next, a second tubular member is placed within the hollow chamber of the first tubular member. The hose clamp is then translated along the first tubular member to a position overlapping the second tubular member. The hose clamp is then allowed to contract back to the first position from the second position.

### BRIEF DESCRIPTION OF THE DRAWINGS

FIG. 1 shows a perspective view of an embodiment of the present invention;

FIG. 2 shows a force being applied to the embodiment of FIG. 1;

FIG. 3 shows a plan view of an embodiment of the present invention in use;

FIG. 4 shows a plan view of an embodiment of the present invention in an additional use; and

FIG. 5 shows a plan view of an embodiment of the present invention being translated by a user.

### DETAILED DESCRIPTION

For the purposes of promoting and understanding the principles of the present invention, reference will now be made to the embodiment illustrated in the drawings and specification language will be used to describe the same. Nevertheless, by those skilled in the art, it may be understood that no limitation of the scope of the present invention is thereby intended, and further changes in the illustrated device may be made without deviating from the scope of the present invention.

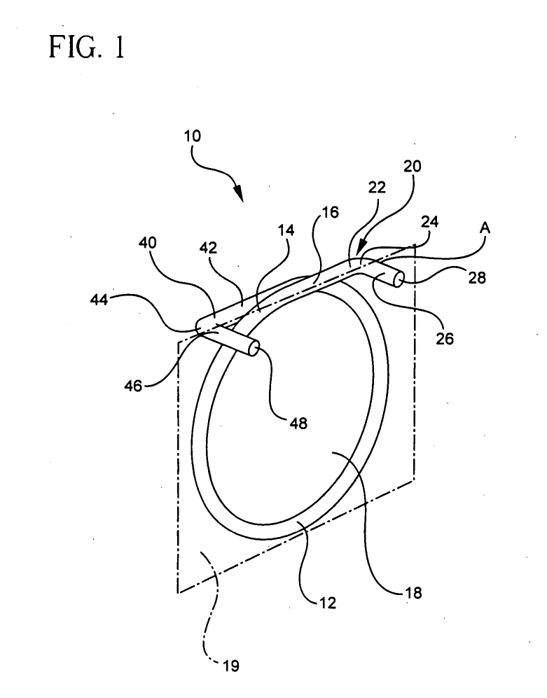

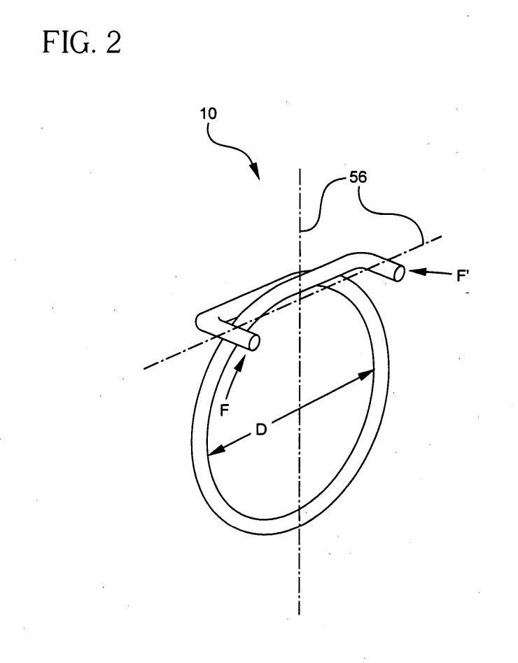

As shown in FIG. 1, hose clamp 10 is preferably constructed from a single body of wire. Preferably, as shown in the figures, the wire has a circular cross-sectional shape. Hose clamp 10 includes an arcuate portion 12 preferably having a substantially circular shape. Arcuate portion 12 preferably includes a first end 14 and a second end 16. The first end 14 may extend past second end 16, thereby permitting arcuate portion 12 to form a substantially and complete circular body. However, in a preferred embodiment, as shown in FIG. 1, first end 14 only approaches second end 16 and does not overlap, therefore, arcuate portion 12 does not form a complete circular body. In this scenario, arcuate portion 12 can be thought of as forming a U-shaped body, where the two opened ends are bent proximate to one another. Arcuate portion 12 forms aperture 18, which therefore may not be completely enclosed. The arcuate portion has a first diameter D, as shown in FIG. 2.

Arcuate portion 12 has a plane 19 extending through the center of the arcuate portion 12.

Hose clamp 10 also preferably includes a proximal extension 20 extending outwardly from first end 14. Proximal extension 20 includes proximal leg 22, proximal elbow 24 and proximal ear 26. Proximal leg 22 extends outward from and is coupled with first end 14. Proximal elbow 24 is attached to an opposite end of proximal leg 22 as compared to first end 14 and bridges proximal leg 22 to proximal ear 26. In a preferred embodiment, proximal elbow 24 has a 90 degree right-angle turn. This results in a longitudinal axis 28 passing through the center of proximal ear 26 being perpendicular to plane 19.

In an alternate embodiment, longitudinal axis 28 may only be angled to plane 19 as opposed to being specifically perpendicular. For example, longitudinal axis 28 may be in a range of from 75 to 115 degrees as measured from angle A in the figure. More preferably, angle A may be between 80 and 110 degrees.

Similarly to the first end 14, second end 16 has distal extension 40 extending outwardly therefrom. Distal extension 40 includes distal leg 42, distal elbow 44 and distal ear 46. Distal extension 40 is preferably similarly constructed to proximal extension 20. More specifically, distal ear 46 also has a longitudinal axis 48 extending therethrough.

Longitudinal axis 48 is similarly structured to longitudinal axis 28 in that the longitudinal axis 48 is angled relative to plane 19. Angle B may be between approximately 70 to 115 degrees, more preferably between 80 to 110 degrees, and most preferably is approximately 90 degrees.

In one embodiment of the present invention, either proximal extension 20 or distal extension 40 may remain disposed in first plane 19. However, in an alternate embodiment, neither proximal extension 20 nor distal extension 40 is disposed entirely in first plane 19.

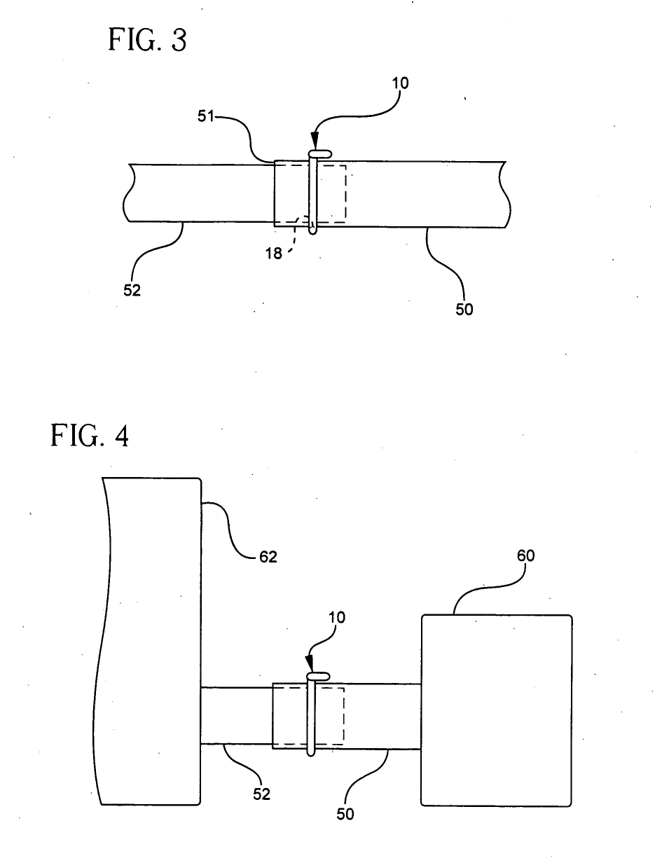

As shown in FIG. 2, hose clamp 10 has a first diameter D. Diameter D is preferably sized so as to tightly fit over hose 50 even when pipe or hose 52 is slidably received within opening 51 of hose 50, as shown in FIG. 3. However, in order to place hose clamp 10 correctly on hose 50, a force F and F′ may be applied to proximal ear 26 and distal ear 46 as shown in FIG. 2. The forces F and F′ are applied against the ears in directions toward one another. In other words, the ears are squeezed in order that they are brought proximate to one another. As the forces F and F′ are applied in a direction through a longitudinal axis 56 passing through the center of hose clamp 10, diameter D is expanded to a second diameter, not shown in the figures. The second diameter preferably has a dimension greater than the dimension of hose 50 enabling hose clamp 10 to be translated along hose 50. Once the hose clamp 10 is translated to the correct position as shown in FIG. 3, the force may be removed from the ears of the hose clamp permitting the self-tightening hose clamp 10 to constrict hose 50 about pipe 52 creating a substantially water and air-tight connection.

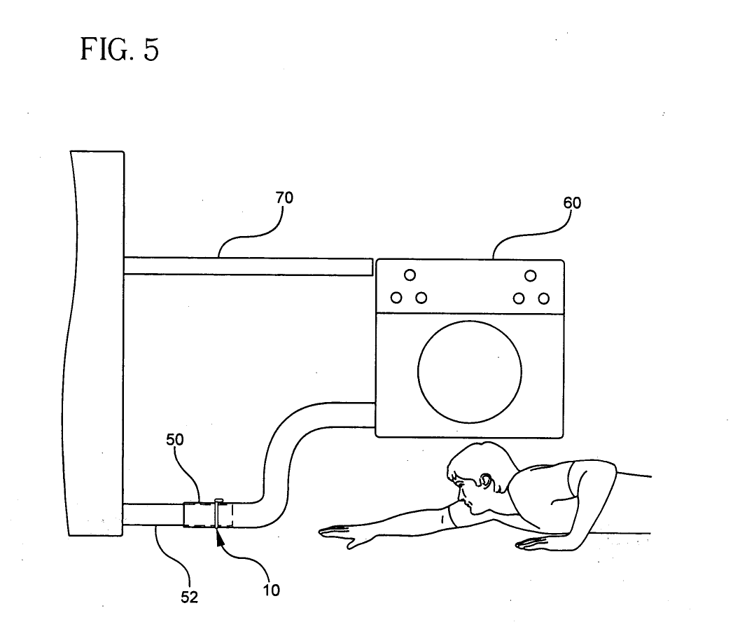

As shown in FIG. 4, the hose clamp is preferably designed to be used in connection with household appliances such as a dish washer, or clothes washing machine 60. In a method of use, hose clamp 10 is first placed around hose 50. In other words, a force is applied to the ears of the hose clamp thereby causing the diameter of the hose clamp to increase. Hose clamp 10, and specifically aperture 18, then slidably receives hose 50. A sufficient length of hose 50 is passed through the hose clamp to permit the hose to be coupled to a second hose or pipe. In such an environment, hose 50 usually extends outwardly from the clothes washing machine towards a wall 62. Wall 62 may have a flange, pipe or additional hose 52 extending towards the hose 50. As previously mentioned, pipe 52 is slidably received within aperture 51 of hose 50. At this point, hose clamp 10 is translated along hose 50 by applying forces F and F′ as shown in FIG. 2. The hose clamp is translated until placed in the correct position.

Often, an appliance such as a dish washer or clothes washing machine, is positioned snuggly between various walls. The appliance may have been put in place by a previous tenant or home owner and then, after being assembled, the walls may have been constructed around the appliance. This increases the difficulty of replacing an appliance in the confined space because one is not able to get at the pipe connection due to the surrounding walls. The new tenant or home owner may be forced to remove one of the walls in order to be able to connect a new appliance.

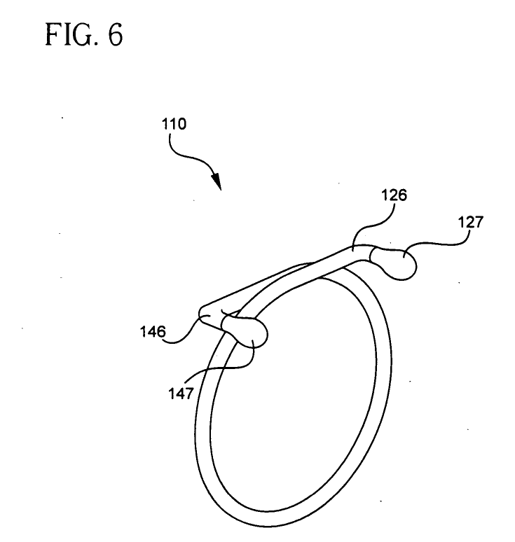

As shown in FIG. 5, a ledge 70 may be positioned over or abutting appliance 60. The ledge 70 restricts the ability of a person to be able to place their hands on the hose clamp from above appliance 60. The only access to the hose clamp may be from underneath or adjacent the side of the appliance 60. Therefore, rather than from a position perpendicular to the direction of movement of the hose clamp one would desire, i.e., from a vertical position when you intend to translate the hose clamp horizontally, a person is forced to contact the hose clamp from a horizontal position in order to translate the hose clamp horizontally along the hose. In other words, a person may be forced to lay on their front underneath the appliance 60 and extend their arm outward as shown in the figure.

Unfortunately, prior art hose clamps are not designed for this type of construction. This is mainly because the ears and extensions of the prior art products are designed to have a force applied from a vertical position. If one were to try to provide a force while laying in a horizontal position and try to move the prior art hose clamps horizontally at the same time, often the bottom half of the arcuate portion of the clamp would consistently come into contact with hose 50 as the top half of the arcuate portion is pushed forward. Therefore, a person would constantly have to reposition the hose clamp in their hand as they inch the hose clamp down the longitudinal axis of hose 50.

The construction of the present invention provides the advantage that once the forces F and F′ are provided to hose clamp 10 and the hose clamp is in the unlocked diameter position, hose clamp 10 is easily moved along a hose horizontally even if a person or tool is also extending horizontally relative to the horizontal direction of movement.

Although the present invention has been described with references to appliances and wall connections, the present invention is equally adaptable to tight, confining spaces such as those found in the workings of various tools and appliances as well as cars and additional motor vehicles. The added benefit of being able to contact a hose clamp horizontally and move that hose clamp in the same direction along a hose, allows the hose pipe connection to be conducted in tighter spaces than was previously allowed.

In one embodiment of the present invention, proximal ear 126 and distal ear 146 of hose clamp 110, have flattened ends 127 and 147 as shown in FIG. 6. Ends 127 and 147 increase the area of contact for a tool and hand to grip and squeeze the ears. The flattened ends may simply be formed by placing a sufficient amount of pressure against the wire, causing the circular cross-sectional shape of the wire to deform.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A self-tightening hose clamp comprising:
a flexible member having a substantially circular shape disposed in a first plane, said flexible member expandable from a first position defining a first opening to a second position defining a second opening, said second opening being larger than said first opening, said flexible member having first and second spaced apart ends;
a first projection extending from said first end of said flexible member on one side of said first plane, said first projection having a longitudinal axis arranged substantially perpendicular to said first plane;
a second projection extending from said second end of said flexible member on said one side of said first plane, said second projection having a longitudinal axis arranged substantially perpendicular to said first plane, wherein manipulation of said first and second projections towards each other causes said flexible member to expand from said first position to said second position.

2. The self-tightening hose clamp of claim 1, wherein said first projection is coupled to said first end by a first elbow.

3. The self-tightening hose clamp of claim 1, wherein said second projection is coupled to said second end by a second elbow.

4. The self-tightening hose clamp of claim 1, wherein said first and second ends have flattened ends.

5. A self-tightening hose clamp comprising:
a substantially circular shaped member disposed in a first plane, said member defining a substantially circular opening, said member having end portions overlapping one another; and
a first leg extending from one of said end portions on one side of said first plane at a first angle thereto;
a second leg extending from the other of said end portions on said one side of said first plane at said first angle thereto,
whereby displacement of said first and second legs towards each other causes said opening to increase in size by expansion of said member.

6. The self-tightening hose clamp of claim 5, wherein said first angle is in the range of about 75-115 degrees.

7. The self-tightening hose clamp of claim 5, wherein said first angle is about 90 degrees.

8. The self-tightening hose clamp of claim 5, wherein said first and second legs are coupled to said end portions by an elbow.

9. The self-tightening hose clamp of claim 8, wherein said elbow forms a 90 degree angle.

10. The self-tightening hose clamp of claim 5, wherein said end portions comprise straight segments.

11. A self-tightening hose clamp comprising:
a flexible arcuate portion having a substantially circular shape defining an aperture and disposed in a plane, said arcuate portion having a first diameter when in a rest position, and a second diameter when in an open position, said arcuate portion having a first end and a second end;
a first extension extending from said first end, said first extension including a first elbow and a first ear, said first elbow and said first ear disposed within a first plane, wherein said first plane is orthogonal to said plane of said arcuate portion;
a second extension extending from said second end, said second extension including a second elbow and a second ear, said second elbow and said second ear disposed within a second plane, wherein said second plane is orthogonal to said plane of said arcuate portion; and
wherein when said first ear and said second ear are brought proximate to one another, said arcuate portion is caused to expand from said first position to said second position.

12. The self-tightening hose clamp of claim 11, wherein said first and second ears extend in a first direction.

13. The self-tightening hose clamp of claim 11, wherein said first extension further includes a first leg and said second extension further includes a second leg, said first leg connecting said first end of said arcuate portion to said first elbow and said second leg connecting said second end to said second elbow.

14. The self-tightening hose clamp of claim 13, wherein one of said first leg or said second leg is disposed in said first plane.

15. The self-tightening hose clamp of claim 13, wherein neither of said first leg or said second leg is disposed in said first plane.

16. The self-tightening hose clamp of claim 11, wherein neither of said first leg or said second leg is disposed in said first plane.

17. The self-tightening hose clamp of claim 11, wherein said first ear and said second ear are at an angle to said plane of said arcuate portion, said angle being approximately between 75 degrees and 115 degrees.

18. The self-tightening hose clamp of claim 11, wherein said first ear and said second ear are at an angle to said first plane, said angle being approximately between 80 degrees and 110 degrees.

19. The self-tightening hose clamp of claim 11, wherein said first ear and said second ear have flattened ends.

20. A method of applying a self-tightening hose clamp, comprising the steps of:
providing a flexible member having a substantially circular shape disposed in a first plane, said flexible member expandable from a first position defining a first opening to a second position defining a second opening, said second opening being larger than said first opening, said flexible member having first and second spaced apart ends, said flexible member having a first projection extending from said first end of said flexible member on one side of said first plane, said first projection having a longitudinal axis arranged substantially perpendicular to said first plane, and a second projection extending from said second end of said flexible member on said one side of said first plane, said second projection having a longitudinal axis arranged substantially perpendicular to said first plane, wherein manipulation of said first and second projections towards each other causes said flexible member to expand from said first position to said second position;
expanding said flexible member from said first position to said second position;
slidably receiving a first tubular member in said opening of said hose clamp and translating said hose clamp in a first direction along said first tubular member, said tubular member having a hollow chamber extending therethrough;
placing a second tubular member within said hollow chamber of said first tubular member;
translating said hose clamp along said first tubular member to a position overlapping said second tubular member; and
allowing said hose clamp to contract back to said first position from said second position.

21. The method according to claim 10, wherein the steps of translating said hose clamp include providing a force against said first and second ears, thereby causing said arcuate portion to go from said first position having a first diameter to a second position having a second diameter, said first diameter being larger than said second diameter.
